(19) United States
(12) Patent Application Publication
(10) Pub. No.: US 2020/0110859 A1
(43) Pub. Date: Apr. 9, 2020

(54) CONTROLLING ACCESS TO COMPUTER RESOURCES BY USER AUTHENTICATION BASED ON UNIQUE AUTHENTICATION PATTERNS

(71) Applicant: CA, Inc., New York, NY (US)

(72) Inventors: Vijay Shashikant Kulkarni, Bangalore (IN); Lyju Vadassery, Mumbai (IN); Vikrant Nandakumar, Bangalore (IN); Harmeet Singh Gujral, Bengaluru (IN)

(73) Assignee: CA, Inc., New York, NY (US)

(21) Appl. No.: 16/151,613

(22) Filed: Oct. 4, 2018

(51) Int. Cl. G06F 21/31; H04L 29/06; G06F 17/30

(52) U.S. Cl. CPC G06F 21/31; H04L 63/102; G06F 17/30634; H04L 63/08

(57) ABSTRACT

An account server receives from a user terminal an access request message containing an account identifier. A security question is retrieved from an accounts database. An authentication query message containing the security question is communicated toward the user terminal. A registered text counting rule that is associated with the account identifier is retrieved from the accounts database. Text of the security question is processed using the registered text counting rule to generate a computed security number. An authentication response message containing an answer from the user to the security question is received. A determination is made whether the answer from the user matches the computed security number. The operations selectively allow electronic access by the user terminal to information stored in a data structure associated with the account identifier within the accounts database, based on whether the answer contained in the authentication response message matches the computed security number.

### BACKGROUND

The present disclosure relates to electronic devices and, more particularly, to user interfaces for portable electronic devices.

Passwords remain the dominant means of authentication in computer systems because of their simplicity, legacy deployment and ease of revocation. Unfortunately, common approaches to entering passwords by way of keyboard, mouse, touch screen or any traditional input device, are frequently vulnerable to attacks such as shoulder surfing and password snooping.

Shoulder-surfing is an attack on password authentication that has traditionally been hard to defeat. It can be done remotely using binoculars and cameras, using keyboard acoustics, or embedded keystroke tracking software. Access to the user's password simply by observing the user while he or she is entering a password undermines the effort put into encrypting passwords and protocols for authenticating the user securely. To some extent, the human actions when inputting the password are the weakest link in the chain.

Consequently, a person is using a shared/entrusted device to access a net banking account, it can be very risky due to shoulder-surfing attacks or other attacks that may arise from keylogger software that is present on the device. Risk also arises when using a shared Wi-Fi network or other entrusted network where communications may be electronically spied upon

### SUMMARY

Some embodiments of the present disclosure are directed to a method of performing operations on an account server processor. The operations include receiving an access request message from a user terminal operated by a user, where the access request message contains an account identifier. The operations retrieve a security question from an accounts database, and generate authentication query message containing the security question. The authentication query message is communicated toward the user terminal. The operations retrieve from the accounts database a registered text counting rule that is associated with the account identifier. The operations process text of the security question using the registered text counting rule to generate a computed security number. The operations receive from the user terminal an authentication response message containing an answer from the user to the security question. A determination is made whether the answer from the user matches the computed security number. The operations selectively allow electronic access by the user terminal to information stored in a data structure associated with the account identifier within the accounts database, based on whether the answer contained in the authentication response message matches the computed security number.

Some other embodiments of the present disclosure are directed to a corresponding account server that includes a network interface configured to communicate with user terminals through a data network, a processor coupled to the network interface, and a memory coupled to the processor and storing computer readable program code that when executed by the processor causes the processor to perform operations. The operations include receiving an access request message from a user terminal operated by a user via the network interface, where the access request message contains an account identifier. The operations retrieve a security question from an accounts database, and generate authentication query message containing the security question. The authentication query message is communicated toward the user terminal. The operations retrieve from the accounts database a registered text counting rule that is associated with the account identifier. The operations process text of the security question using the registered text counting rule to generate a computed security number. The operations receive from the user terminal via the network interface an authentication response message containing an answer from the user to the security question. A determination is made whether the answer from the user matches the computed security number. The operations selectively allow electronic access by the user terminal to information stored in a data structure associated with the account identifier within the accounts database, based on whether the answer contained in the authentication response message matches the computed security number.

Other methods, account servers, and computer program products according to embodiments of the inventive subject matter will be or become apparent to one with skill in the art upon review of the following drawings and detailed description. It is intended that all such additional methods, account servers, and computer program products be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a user terminal and an account server that can authenticate a user who is operating the user terminal according to some embodiments of the present disclosure;

FIGS. 2 to 4 illustrate example information that may be displayed on the user terminal responsive to messaging from the account server performing operations according to some embodiments of the present disclosure;

FIG. 5 illustrates a combined dataflow diagram and flowchart of operations that may be performed by the account server and the user terminal to control electronic access to information stored in an accounts database according to some embodiments of the present disclosure;

FIG. 6 illustrates a flowchart of operations that may be performed by the account server processor according to some embodiments of the present disclosure; and

FIG. 7 illustrates a block diagram of an account server having components configured to operate according to some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As explained above, password entry remains a weakness in efforts to improve user authentication effectiveness. Some systems attempt to authenticate users through a combination of requiring a user to enter a valid password or other credential(s) and to correctly answer a security question that is displayed on the user terminal. One security weakness with this approach is that the security questions may be properly guessed by someone who has enough background knowledge of the person to answer common security questions related to, for example, the city where the user last went to school, the user's mother's maiden name, the user's pet name, etc. These known approaches for user authentication require that all or a defined number of the displayed security questions be properly answered.

Various embodiments of the present disclosure are directed to providing more secure multi-factor authentication of users.

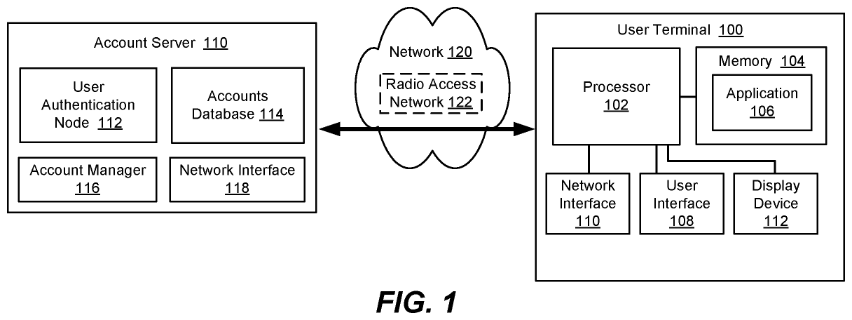

FIG. 1 is a block diagram of a user terminal 100 and an account server 110 that can authenticate a user who is operating the user terminal 110 according to some embodiments of the present disclosure. Referring to FIG. 1, the account server 110 communicates with the user terminal 100 through a data network 120 that may include wired (e.g., private or public wide area network (e.g., Internet)) and/or wireless network elements. For example, the data network 120 may include a radio access network 122 that communicates with the account server 110 and/or the user terminal 100 using one or more wireless communication protocols, such as WiFi, WiMax, LTE or other cellular, etc. The user terminal 100 may be any electronic device that can communicate with the account server 110, such as a smart phone, tablet computer, laptop computer, desktop computer, gaming console, etc.

The illustrated user terminal 100 includes a processor 102, a memory 104, a user interface 108, a display device 109, and a network interface 110. The network interface 110 may include a radio access network transceiver and/or a wired network interface (e.g., Ethernet interface). The user interface 108 may include a keyboard, touch screen input interface, speaker, and/or microphone. The processor 102 may include one or more data processing circuits, such as a general purpose and/or special purpose processor (e.g., microprocessor and/or digital signal processor) that may be collocated or distributed across one or more networks. The processor 102 is configured to execute computer program code 106 in the memory 104, described below as a non-transitory computer readable medium, to perform at least some of the operations described herein as being performed by a user terminal.

The account server 110 may include an accounts database 114, a user authentication node 112, an account manager 116, and a network interface 118. The network interface 118 communicates with the user terminal 100 through the data network 120. The accounts database 114 is a data repository that stores user credentials, such as user account identifiers and corresponding passwords, in data structures with logical associations to the account identifiers. The user authentication node 112 operates to validate a user who is requesting access via the user terminal 100 to an account managed by the accounts manager 116 and which resides in the accounts database 114. When a user is properly authenticated by the user authentication node 112, the account manager 116 allows the user operating the user terminal 100 to access information (e.g., user data, media content, etc.) residing in the accounts database 114 associated with the account identifier or otherwise made accessible to authenticated users. Selective information access can be provided by the account manager 116 selectively passing information request query messages from the user terminal 100 to the accounts database 114.

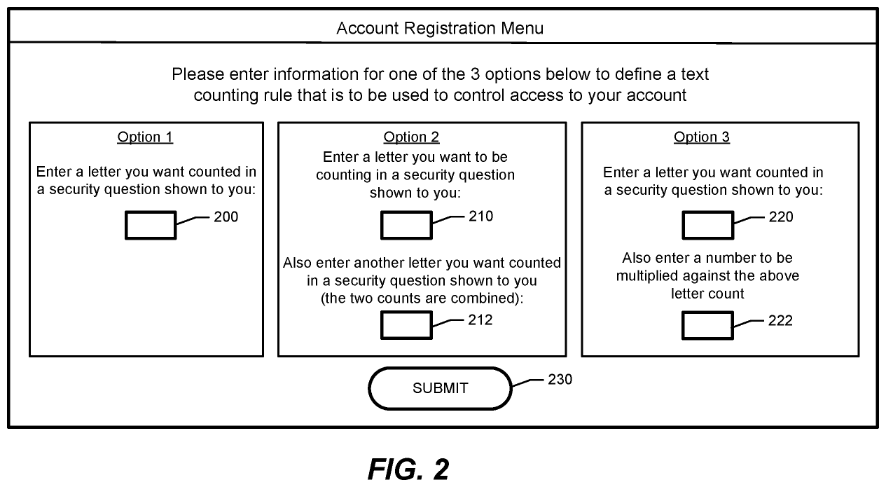

Various example operations that can be performed in accordance with some embodiments now be described in the context of the user interface of be provided by the account server 110 for display on the user terminal 100. FIGS. 2 to 4 illustrate example information that may be displayed on the user terminal 100 responsive to messaging from the account server 110 performing operations according to some embodiments of the present disclosure.

Referring to FIG. 2, a user can be prompted to enter information that is used by the account server 110 to define a text counting rule that is to be used to control access to the user's account. In the illustration of FIG. 2, the user is provided three options for inputting information that is used by the account server 110 to define a text counting rule.

In Option 1, the user enters a letter (e.g., letter “a”) into input field 200 which the account server 110 is to count each occurrence of in any security question, which will be displayed to the user during an account login operation, to generate a computed security number. As will be explained below, computed security number is subsequently compared to a security number that is received from the user during an account login operation. In Option 2, the user enters a letter (e.g., letter “a”) into input field 210 which the account server 110 is to count each occurrence of in any security question will be displayed to the user during an account login operation, and also enters another letter (e.g., letter “o”) into input field 212 which the account server 110 is to count each occurrence of in any security question that will be displayed to the user during an account login operation. The account server 110 then generates a computed security number based on both count values. In Option 3, the user enters a letter (e.g., letter “a”) into input field 220 which the account server 110 is to count each occurrence of in any security question will be displayed to the user during an account login operation, and also enters a multiplier number (e.g., number “2”) into input field 222 which the account server 110 is to use to multiply the counted number of occurrences of the letter to generate a computed security number. Selection of the user selectable indicia 230 can trigger the inputted information to be communicated from the user terminal 100 to the account server 110.

Referring to FIG. 3, during an account login operation the user is prompted to enter account login credentials, e.g., a security number such as a personal identification number (PIN), into input field 300. In accordance with some embodiments, additional multi-factor authentication is performed responsive to the user selecting a field 310 to request increased security access, such as when the user is using an untrusted user terminal and/or is operating in a public space or other unsecure environment. Selection of the user selectable indicia 320 can trigger the inputted information to be communicated from the user terminal 100 to the account server 110.

Responsive to the user selecting field 310, the account server 110 retrieves a security question from the accounts database 114, and communicates the security question to the user terminal 100 for display. In the particular illustration of FIG. 3, the security question 400 is “Today will be sunny with clouds moving in this evening. Light rain should start around 10:00 PM and continue to 2:00 AM.” The user is prompted to provide an answer to this question and the input field 410. A valid user who has previously defined the text counting rule, applies the text counting rule to generate a numeric answer that is input to field 410. Selection of the user selectable indicia 420 can trigger the inputted answer to be communicated from the user terminal 100 to the account server 110.

By way of further example, according to the text counting rule defined for Option 1, the user counts the number of occurrences of the letter “a” within the question, which results in the user inputting the number “6” into field 410. In contrast, according to the text counting rule defined for Option 2, the user counts the number of occurrences of the letter “a” (i.e., 6) within the question and further counts the number of occurrences of the letter “o” (i.e., 7), adds (or otherwise combines, e.g., multiply, subtract, etc.) the two counts to determine that the number 12 (e.g., 6+7) is the numeric answer to be input to field 410. In contrast, according to the text counting rule defined for Option 3, the user counts the number of occurrences of the letter “a” (i.e., 6) within the question and multiplies that count by the earlier registered multiplier number (i.e., 2) to determine that the number 12 (e.g., 6x2) is the numeric answer to be input to field 410.

The account server 110 receives from the user terminal 100 and authentication response message containing the answer from the user to the security question. The account server 110 determines whether the answer from the user matches the computed security number which the account server 110 has computed by processing text of the security question using the registered text counting rule. The account server 110 then selectively allows electronic access by the user terminal 100 to information stored in a data structure associated with the account identifier within the accounts database 114, based on whether the answer contained in the authentication response message matches the computed security number.

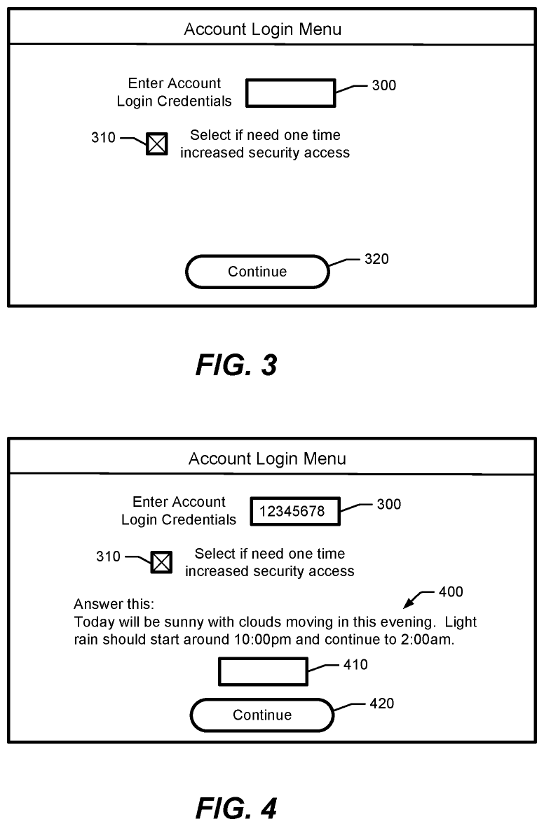

These and other related operations are now described in further detail with reference to FIG. 5. FIG. 5 illustrates a combined dataflow diagram and flowchart of operations that may be performed by the account server 110 and the user terminal 100 to control electronic access to information stored in the accounts database 114 according to some embodiments of the present disclosure.

The user initiates 500 an account login process, such as by initiating execution of an application hosted by the user terminal 100 which will seek electronic access to information stored in the data structure associated with the account identifier of the user within the accounts database 114. The user terminal 100 receives 502 the user entered account identifier and credential string, e.g., password. The user terminal 100 communicates 504 an access request message to the account server 110, where the access request message includes the account identifier and the credential string.

The account server 110 responsively retrieves 506 a security question from the accounts database 114. The security question may be unique to the user's particular account, or may be a security question that is used with some or all of the user accounts. Moreover, the security question may be selected among a set of security questions responsive to the account identifier, a count of number of previous electronic access attempts by the user, a randomly generated number, etc.

The account server 110 generates 508 an authentication query message containing the security question, and communicates the authentication query message toward the user terminal 100. The user terminal 100 receives and displays 510 the security question, and prompts the user to input and answer. The user terminal 100 receives 514 an answer from the user, and communicates 518 the authentication response message containing the answer toward the account server 110.

The account server 110 retrieves 512 from the accounts database 114 a registered text counting rule that is associated with the account identifier. The account server 110 processes 516 text of the security question using the registered text counting rule to generate a computed security number, such as described above regarding FIGS. 1 and 4 for any of the three example Options. Account server 110 receives 520 from the user terminal 100 the authentication response message containing the answer from the user to the security question. The account server 110 determines 522 whether the answer from the user matches the computed security number.

The account server 110 then selectively 524 allows electronic access by the user terminal 100 to information stored in a data structure associated with the account identifier within the accounts database 114, based on whether the answer contained in the authentication response message matches the computed security number.

The operation to selectively allow electronic access can include preventing electronic access by the user terminal 100 to the information stored in the data structure associated with the account identifier within the accounts database 114, responsive to determining that the answer contained in the authentication response message does not match the computed security number. In contrast, the operation to selectively allow electronic access can further include allowing electronic access by the user terminal 100 to the information stored in the data structure associated with the account identifier within the accounts database 114, responsive to determining that the answer contained in the authentication response message matches the computed security number.

In the illustrated example of FIG. 5, responsive to the determination of whether the answer from the user matches the computed security number, the account server 110 can communicate 526 a message to the user terminal 100 that either allows or denies completion of the login operation. The user terminal 100 receives 528 the message and displays the login completion indication, when contained in the message, or display a denial of login indication. If account login is allowed to complete, the user terminal 100 communicates 530 an electronic access request message containing an identifier of information (e.g., URI) that is requested from the account server 110. If the account login process is completed, the account server 110 retrieves and communicates 532 information from the accounts database 114 responsive to the information identifier. The user terminal 100 receives 534 the information from the account server 110, which is provided to an application programming interface of the application being executed by the user terminal 100.

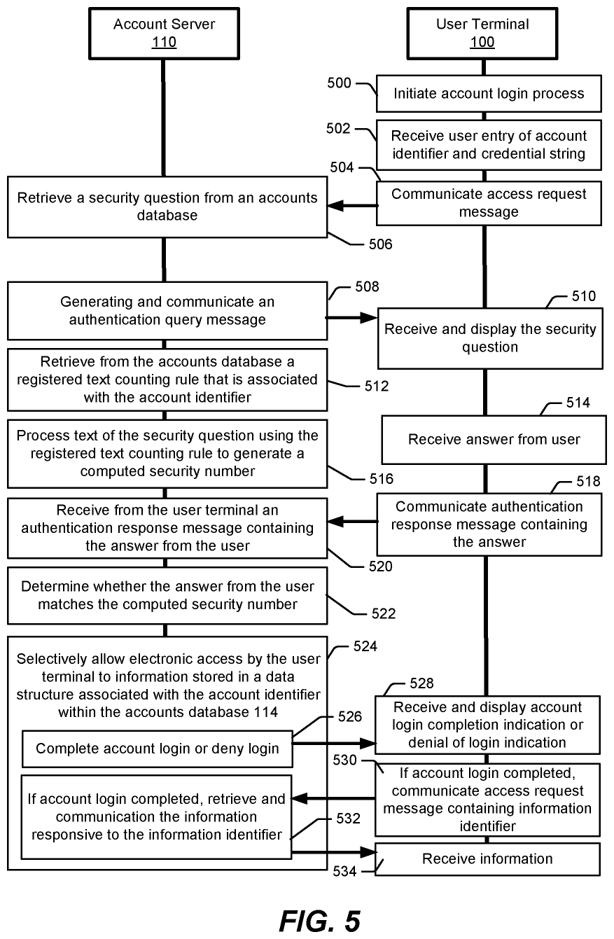

Various operations are shown in FIG. 6 that can be performed by the account server 110 as part of a user registration process to generate a registered text counting rule for later use to verify the user. Referring to FIG. 6, the account server 110 communicates 600 a registration message to the user terminal 100 containing a request for the user to define a text counting rule. The account server 110 receives 602 a registration response from the user containing data defining the text counting rule. The account server 110 generates 604 the registered text counting rule based on the data defining the text counting rule that was received from the user, and stores 606 the registered text counting rule in the data structure associated with the account identifier within the accounts database 114.

The operation to generate 604 the registered text counting rule based on the data defining the text counting rule that was received from the user, can include configuring the registered text counting rule to count a number of occurrences of a letter is identified by the registration response. The operation to process 516 (FIG. 5) text of the security question using the registered text counting rule to generate the computed security number, can include counting a number of occurrences of the letter, which is identified by the registration response, in the text of the security question to generate the computed security number.

In an alternative or additional embodiment, the operation to generate 604 the registered text counting rule based on the data defining the text counting rule that was received from the user, can further include configuring the registered text counting rule to multiply the count, of the number of occurrences of the letter, by a multiplier number that is identified by the registration response. The operation to process 516 (FIG. 5) text of the security question using the registered text counting rule to generate the computed security number, can include multiplying the counted number of occurrences of the letter by the multiplier number to generate the computed security number.

In an alternative or additional embodiment, the operation to generate 604 the registered text counting rule based on the data defining the text counting rule that was received from the user, can further include configuring the registered text counting rule to add an offset number that is identified by the registration response to the count of the number of occurrences of the letter. The operation to process 516 (FIG. 5) text of the security question using the registered text counting rule to generate the computed security number, can include adding the offset number to the count of the number of occurrences of the letter to generate the computed security number.

In an alternative or additional embodiment, the operation to generate 604 the registered text counting rule based on the data defining the text counting rule that was received from the user, can further include configuring the registered text counting rule to count another letter that is identified by the registration response. The operation to process 516 (FIG. 5) text of the security question using the registered text counting rule to generate the computed security number, can include counting the number of occurrences of the letter, which is identified by the registration response, in the text of the security question to generate a first count, counting a number of occurrences of the other letter, which is identified by the registration response, in the text of the security question to generate a second count, and combining values of the first and second counts to generate the computed security number.

The operation to retrieve 512 (FIG. 5) from an accounts database 114 a security question can include generating a random number responsive to receipt of the access request message from the user terminal 100, and selecting the security question from among a set of security questions in the accounts database 114 responsive to the random number.

Alternatively or additionally, the operation to retrieve 512 (FIG. 5) from an accounts database 114 a security question can include generating a set of random numbers responsive to receipt of the access request message from the user terminal. For each of the random numbers in the set of random numbers, the operations select a word from among a set of words in the accounts database responsive to the random number. The operations then combine the words to generate the text of the security question.

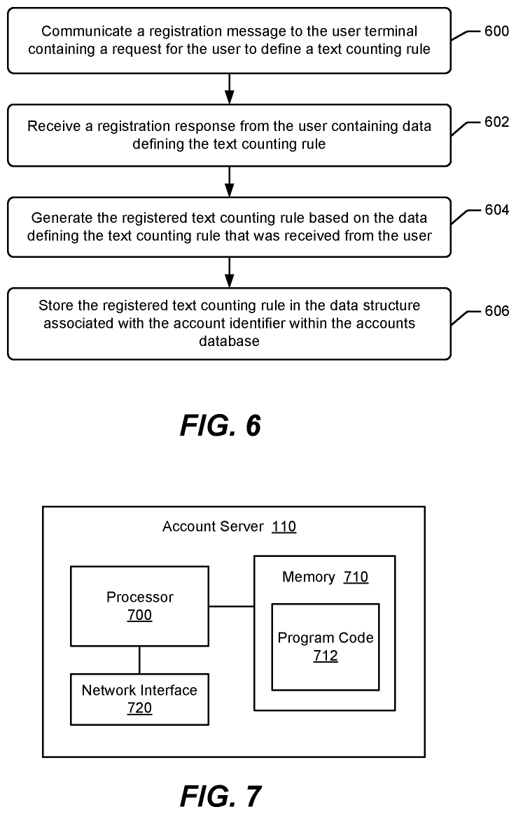

FIG. 7 illustrates a block diagram of an account server 110 that is configured according to some embodiments. Referring to FIG. 7, the account server 110 includes a processor 700, a memory 710, and a network interface 720. The processor 700 may include one or more data processing circuits, such as a general purpose and/or special purpose processor (e.g., microprocessor and/or digital signal processor) that may be collocated or distributed across one or more networks. The processor 700 is configured to execute computer program code 712 in the memory 710, described below as a non-transitory computer readable medium, to perform at least some of the operations described herein as being performed by an account server 110 or any component thereof. Any part of the components illustrated in the account server 110 may reside in another networked computer processing node and/or within the user terminal 100.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method, comprising:
performing operations as follows on an account server processor:
receiving an access request message from a user terminal operated by a user, wherein the access request message contains an account identifier;
retrieving a security question from an accounts database;
generating an authentication query message containing the security question;
communicating the authentication query message toward the user terminal;
retrieving from the accounts database a registered text counting rule that is associated with the account identifier;
processing text of the security question using the registered text counting rule to generate a computed security number;
receiving from the user terminal an authentication response message containing an answer from the user to the security question;
determining whether the answer from the user matches the computed security number; and
selectively allowing electronic access by the user terminal to information stored in a data structure associated with the account identifier within the accounts database, based on whether the answer contained in the authentication response message matches the computed security number.

2. The method of claim 1, wherein the operation to selectively allow electronic access comprises:
preventing electronic access by the user terminal to the information stored in the data structure associated with the account identifier within the accounts database, responsive to determining that the answer contained in the authentication response message does not match the computed security number.

3. The method of claim 2, wherein the operation to selectively allow electronic access further comprises:
allowing electronic access by the user terminal to the information stored in the data structure associated with the account identifier within the accounts database, responsive to determining that the answer contained in the authentication response message matches the computed security number.

4. The method of claim 1, the operations further comprising:
communicating a registration message to the user terminal containing a request for the user to define a text counting rule;
receiving a registration response from the user containing data defining the text counting rule;
generating the registered text counting rule based on the data defining the text counting rule that was received from the user; and
storing the registered text counting rule in the data structure associated with the account identifier within the accounts database.

5. The method of claim 4, wherein:
the operation to generate the registered text counting rule based on the data defining the text counting rule that was received from the user, comprises configuring the registered text counting rule to count a number of occurrences of a letter is identified by the registration response; and
the operation to process text of the security question using the registered text counting rule to generate the computed security number, comprises counting a number of occurrences of the letter, which is identified by the registration response, in the text of the security question to generate the computed security number.

6. The method of claim 5, wherein:
the operation to generate the registered text counting rule based on the data defining the text counting rule that was received from the user, further comprises configuring the registered text counting rule to multiply the count, of the number of occurrences of the letter, by a multiplier number that is identified by the registration response; and
the operation to process text of the security question using the registered text counting rule to generate the computed security number, comprises multiplying the counted number of occurrences of the letter by the multiplier number to generate the computed security number.

7. The method of claim 5, wherein:
the operation to generate the registered text counting rule based on the data defining the text counting rule that was received from the user, further comprises configuring the registered text counting rule to add an offset number that is identified by the registration response to the count of the number of occurrences of the letter; and
the operation to process text of the security question using the registered text counting rule to generate the computed security number, comprises adding the offset number to the count of the number of occurrences of the letter to generate the computed security number.

8. The method of claim 5, wherein:
the operation to generate the registered text counting rule based on the data defining the text counting rule that was received from the user, further comprises configuring the registered text counting rule to count another letter that is identified by the registration response; and
the operation to process text of the security question using the registered text counting rule to generate the computed security number, further comprises:
counting the number of occurrences of the letter, which is identified by the registration response, in the text of the security question to generate a first count;
counting a number of occurrences of the other letter, which is identified by the registration response, in the text of the security question to generate a second count; and
combining values of the first and second counts to generate the computed security number.

9. The method of claim 1, wherein the operation to retrieve from an accounts database a security question comprises:
generating a random number responsive to receipt of the access request message from the user terminal; and
selecting the security question from among a set of security questions in the accounts database responsive to the random number.

10. The method of claim 1, wherein the operation to retrieve from an accounts database a security question comprises:
generating a set of random numbers responsive to receipt of the access request message from the user terminal;
for each of the random numbers in the set of random numbers, selecting a word from among a set of words in the accounts database responsive to the random number; and
combining the words to generate the text of the security question.

11. An account server comprising:
a network interface configured to communicate with user terminals through a data network;
a processor coupled to the network interface; and
a memory coupled to the processor and storing computer readable program code that when executed by the processor causes the processor to perform operations comprising:
receiving an access request message from a user terminal operated by a user via the network interface, wherein the access request message contains an account identifier;
retrieving from an accounts database a security question;
generating an authentication query message containing the security question;
communicating the authentication query message toward the user terminal via the network interface;
retrieving from the accounts database a registered text counting rule that is associated with the account identifier;
processing text of the security question using the registered text counting rule to generate a computed security number;
receiving from the user terminal via the network interface an authentication response message containing an answer from the user to the security question;
determining whether the answer from the user matches the computed security number; and
selectively allowing electronic access by the user terminal to information stored in a data structure associated with the account identifier within the accounts database, based on whether the answer contained in the authentication response message matches the computed security number.

12. The account server of claim 11, wherein the operation to selectively allow electronic access comprises:
preventing electronic access by the user terminal to the information stored in the data structure associated with the account identifier within the accounts database, responsive to determining that the answer contained in the authentication response message does not match the computed security number.

13. The account server of claim 12, wherein the operation to selectively allow electronic access comprises:
allowing electronic access by the user terminal to the information stored in the data structure associated with the account identifier within the accounts database, responsive to determining that the answer contained in the authentication response message matches the computed security number.

14. The account server of claim 11, the operations further comprising:
communicating a registration message to the user terminal containing a request for the user to define a text counting rule;
receiving a registration response from the user containing data defining the text counting rule;
generating the registered text counting rule based on the data defining the text counting rule that was received from the user; and
storing the registered text counting rule in the data structure associated with the account identifier within the accounts database.

15. The account server of claim 14, wherein:
the operation to generate the registered text counting rule based on the data defining the text counting rule that was received from the user, comprises configuring the registered text counting rule to count a number of occurrences of a letter is identified by the registration response; and
the operation to process text of the security question using the registered text counting rule to generate the computed security number, comprises counting a number of occurrences of the letter, which is identified by the registration response, in the text of the security question to generate the computed security number.

16. The account server of claim 15, wherein:
the operation to generate the registered text counting rule based on the data defining the text counting rule that was received from the user, further comprises configuring the registered text counting rule to multiply the count, of the number of occurrences of the letter, by a multiplier number that is identified by the registration response; and
the operation to process text of the security question using the registered text counting rule to generate the computed security number, comprises multiplying the counted number of occurrences of the letter by the multiplier number to generate the computed security number.

17. The account server of claim 15, wherein:
the operation to generate the registered text counting rule based on the data defining the text counting rule that was received from the user, further comprises configuring the registered text counting rule to add an offset number that is identified by the registration response to the count of the number of occurrences of the letter; and
the operation to process text of the security question using the registered text counting rule to generate the computed security number, comprises adding the offset number to the count of the number of occurrences of the letter to generate the computed security number.

18. The account server of claim 15, wherein:
the operation to generate the registered text counting rule based on the data defining the text counting rule that was received from the user, further comprises configuring the registered text counting rule to count another letter that is identified by the registration response; and
the operation to process text of the security question using the registered text counting rule to generate the computed security number, further comprises:
counting the number of occurrences of the letter, which is identified by the registration response, in the text of the security question to generate a first count;
counting a number of occurrences of the other letter, which is identified by the registration response, in the text of the security question to generate a second count; and
combining values of the first and second counts to generate the computed security number.

19. The account server of claim 11, wherein the operation to retrieve from an accounts database a security question comprises:
generating a random number responsive to receipt of the access request message from the user terminal; and
selecting the security question from among a set of security questions in the accounts database responsive to the random number.

20. The account server of claim 11, wherein the operation to retrieve from an accounts database a security question comprises:
generating a set of random numbers responsive to receipt of the access request message from the user terminal;
for each of the random numbers in the set of random numbers, selecting a word from among a set of words in the accounts database responsive to the random number; and
combining the words to generate the text of the security question.
